(19) United States
(12) Patent Application Publication
(10) Pub. No.: US 2023/0073082 A1
(43) Pub. Date: Mar. 9, 2023

(54) RECYCLING METHOD OF POLYESTER WOOL BLENDED FABRIC

(71) Applicant: NAN YA PLASTICS CORPORATION, Taipei (TW)

(72) Inventors: Te-Chao Liao, TAIPEI (TW); Jung-Jen Chuang, TAIPEI (TW); Zhang-Jian Huang, TAIPEI (TW); Chung-Chi Su, TAIPEI (TW)

(73) Assignee: NAN YA PLASTICS CORPORATION, TAIPEI (TW)

(21) Appl. No.: 17/499,889

(22) Filed: Oct. 13, 2021

(30) Foreign Application Priority Data
Sep. 9, 2021 (TW) 110133650

(51) Int. Cl. D06M 13/192; B01D 39/10; D06M 13/188; C08J 11/26; C08J 11/16

(52) U.S. Cl. CPC D06M 13/192; B01D 39/10; D06M 13/188; C08J 11/26; C08J 11/16; D06M 2101/32

(57) ABSTRACT

Provided is a recycling method of polyester wool blended fabric, which includes the following. A polyester wool blended fabric containing a dye is put into an acidic aqueous solution containing an oxidizing agent for heating and soaking, so as to degrade a wool in the polyester wool blended fabric, and perform decolorization at the same time to remove the dye. After that, a polyester fabric is obtained by filtration.

### CROSS-REFERENCE TO RELATED APPLICATION

This application claims the priority benefit of Taiwanese application no. 110133650, filed on Sep. 9, 2021. The entirety of the above-mentioned patent application is hereby incorporated by reference herein and made a part of this specification.

### BACKGROUND

### Technical Field

The disclosure relates to a recycling method of a fabric. Particularly, the disclosure relates to a recycling method of a polyester wool blended fabric.

### Description of Related Art

In the recycling and reusing technology of a polyester wool blended fabric, cotton is required to be separated and decolorized before polyester and wool in the blended fabric can be recycled and reused. In the separation process, conventional separation is generally achieved by using an organic acid aqueous solution to degrade the wool. However, since dyes may still remain in the separated polyester fabric, it is required to further remove the dye for the decolorization before the polyester can be recycled and reused, which accordingly increases the costs and complicates the procedures. Moreover, even if the wool fiber in the polyester wool blended fabric is degraded by using biological enzymes without affecting the polyester fiber, dyes may still remain in the polyester fiber separated by filtration, further decolorization is required. Furthermore, even when the wool fiber in the polyester wool blended fabric is degraded into keratin with sodium hydroxide aqueous solution without affecting the polyester fiber to achieve separation, dyes may still remain in the polyester fiber, so further decolorization is required.

Based on the above, to develop a recycling method of a polyester wool blended fabric in which separation and decolorization may are performed at the same time, thus reducing the costs and simplifying the procedures, is currently an issue for research.

### SUMMARY

The disclosure provides a recycling method of a polyester wool blended fabric, in which soaking is performed by using an acidic aqueous solution containing an oxidizing agent, and separation and decolorization may be performed at the same time, thus reducing the costs and simplifying the procedures.

The recycling method of a polyester wool blended fabric of the disclosure includes the following. A polyester wool blended fabric containing a dye is put into an acidic aqueous solution containing an oxidizing agent for heating and soaking, so as to degrade a wool in the polyester wool blended fabric, and perform decolorization at the same time to remove the dye. After that, a polyester fabric is obtained by filtration.

In an embodiment of the disclosure, the dye includes a physical dye or a chemical dye.

In an embodiment of the disclosure, the soaking is performed at a temperature higher than a glass transition temperature of polyester.

In an embodiment of the disclosure, the soaking is performed in the acidic aqueous solution at a temperature of 130° C. to 200° C.

In an embodiment of the disclosure, the acidic aqueous solution contains an organic acid, and the organic acid is a monoacid, a dibasic acid, or an acid anhydride having 1 to 18 carbons, and comprises formic acid, acetic acid, acetic anhydride, oxalic acid, propionic acid, malonic acid, butyric acid, succinic acid, valeric acid, glutaric acid, caproic acid, adipic acid, isooctanoic acid, citric acid, maleic acid, maleic anhydride, benzoic acid, or cyclohexanoic acid.

In an embodiment of the disclosure, the organic acid in the acidic aqueous solution has a concentration of 0.1 wt % to 3.0 wt %.

In an embodiment of the disclosure, the oxidizing agent in the acidic aqueous solution has a concentration of 0.06 wt % to 1.2 wt %.

In an embodiment of the disclosure, a weight ratio of the polyester wool blended fabric to the acidic aqueous solution is 1:8 to 1:30.

In an embodiment of the disclosure, the soaking is performed for a duration of 0.5 hours to 3 hours.

In an embodiment of the disclosure, the oxidizing agent comprises hydrogen peroxide, potassium permanganate, calcium hypochlorite, ozone, nitric acid, nitrate, sodium chlorate, calcium chlorate, chlorates, perchlorate, sodium hypochlorite, hypochlorite, sodium perborate, sodium dichromate, dichromate, or a combination thereof.

In an embodiment of the disclosure, the filtration is by using a filter screen of 1 mm to 30 mm.

In an embodiment of the disclosure, the polyester fabric that is obtained has an L value of 75% or more, an a value of ±4, and a b value of ±8.

Based on the foregoing, the disclosure provides a recycling method of a polyester wool blended fabric, in which soaking is performed by using an acidic aqueous solution containing an oxidizing agent, so as to degrade the wool and remove the dye on the polyester fabric at the same time, and in the same manufacturing process, polyester and wool can be separated, and the decolorized polyester fiber can be obtained. Therefore, it is possible to reduce the costs and simplify the procedures. Moreover, the quality of recycled polyester fabric can be improved and the application fields can be widened, facilitating the subsequent mechanical or chemical recycling of polyester fibers.

### DESCRIPTION OF THE EMBODIMENTS

Embodiments of the disclosure will be described in detail below. However, the embodiments are exemplary, and the disclosure is not limited thereto.

Herein, a range represented by “a numerical value to another numerical value” is a schematic representation for avoiding listing all of the numerical values within the range in the specification. Therefore, the recitation of a specific numerical range covers any numerical value within the numerical range and a smaller numerical range defined by any numerical value in the numerical range, as is the case with expressly specifying the any numerical value and the smaller numerical range in the specification.

The disclosure provides a recycling method of a polyester wool blended fabric, including the following. A polyester wool blended fabric containing a dye is put into an acidic aqueous solution containing an oxidizing agent for heating and soaking, so as to degrade a wool in the polyester wool blended fabric, and perform decolorization at the same time to remove the dye. After that, a polyester fabric is obtained by filtration.

In this embodiment, the dye may include a physical dye or a chemical dye. The acidic aqueous solution contains an organic acid. The organic acid is a monoacid, a dibasic acid, or an acid anhydride having 1 to 18 carbons. Frequently used organic acids include formic acid, acetic acid, acetic anhydride, oxalic acid, propionic acid, malonic acid, butyric acid, succinic acid, valeric acid, glutaric acid, caproic acid, adipic acid, isooctanoic acid, citric acid, maleic acid, maleic anhydride, benzoic acid, cyclohexanoic acid, or the like. The concentration of the organic acid in the acidic aqueous solution is, for example, 0.1 wt % to 3.0 wt %, and preferably 0.2 wt % to 2.0 wt %, for example. The oxidizing agent in the acidic aqueous solution may include hydrogen peroxide, potassium permanganate, calcium hypochlorite, ozone, nitric acid, nitrate, sodium chlorate, calcium chlorate, chlorates, perchlorate, sodium hypochlorite, hypochlorite, sodium perborate, sodium dichromate, dichromate, or a combination thereof. The concentration of the oxidizing agent is, for example, 0.06 wt % to 1.2 wt %, and preferably 0.10 wt % to 0.8 wt %, for example, which reduces the costs.

In this embodiment, the weight ratio of the polyester wool blended fabric to the acidic aqueous solution is, for example, 1:8 to 1:30, and preferably 1:10 to 1:15, for example. The polyester wool blended fabric containing the dye is put into the acidic aqueous solution containing the oxidizing agent for heating and soaking, preferably performed at a temperature higher than the glass transition temperature of polyester, such that the dye may be released into the acidic aqueous solution and the dye may be removed at the same time. For example, the soaking is performed in the acidic aqueous solution at a temperature of 130° C. to 200° C., and preferably at a temperature of 150° C. to 180° C. The soaking is performed for a duration of, for example, 0.5 hours to 3 hours, and preferably 1 hour to 2 hours, for example.

The polyester wool blended fabric contains impurities such as dyes and surface treatment agents. Through the acidic aqueous solution, it is possible to degrade wool into a liquid of small molecules while the polyester fabric structure retained, and to remove the impurities such as dyes with the oxidizing agent and under the acidic environment. After the dyes are removed or the dyes lose their colors, white polyester fabric may be obtained by filtration, where the L value is increased from 20% to more than 75%, the a value is ±4, and the b value is ±8. L, a, and b are three basic coordinates for describing colors, which are the most complete color model frequently used to describe all colors visible to the human eye, where L value indicates brightness (L=0% generates black, L=100% indicates white); the a value indicates a position between red and green (a as a negative value indicates green, and a positive value indicates red); the b value indicates a position between yellow and blue (b as a negative value indicates blue, and a positive value indicates yellow). A higher L value of the recycled fabric indicates whiter and brighter fabric, and more facilitated quality of fabrics (clothes) dyed, processed, and manufactured at the downstream. The filtration is, for example, by using a filter screen of 1 mm to 30 mm, and preferably in the form of a metal filter screen, to separate the polyester fabric and the aqueous solution with degraded wool. Through the recycling method of a polyester wool blended fabric of the disclosure, in the case of an aqueous solution, the IV (molecular weight) of polyester has a reduction amplitude within 10%.

The recycling method of a polyester wool blended fabric provided in the disclosure will be described in detail with experimental examples below. However, the following experimental examples are not intended to limit the disclosure.

### EXPERIMENTAL EXAMPLES

To verify that the recycling method of a wool blended fabric provided in the disclosure includes both separation and decolorization procedures, and that in the same manufacturing process, the polyester and wool can be separated, and the decolorized polyester fiber can be obtained, the following experimental examples are described.

### Embodiment 1

20 g of PET polyester (polyethylene terephthalate)-wool blended fabric (where L=19%, PET polyester was 92% by weight, and wool was 8% by weight) was placed into a 1 L pressure-resistant reaction tank, and 500 ml of water, 10 g of maleic acid, 2.0 g of sodium hypochlorite were put therein, and the mixture was stirred for 2 hr at a temperature of 165° C. After that, the wool was degraded into wool keratin.

Then, the temperature was lowered to 60° C., the PET polyester and the aqueous solution of wool keratin were separated through a 2 mm filter screen, and the PET polyester fabric was washed with 100 ml of water.

The PET polyester fabric was dried at 105° C. for 2 hours, and the obtained PET fabric had a purity of 99.5% as a weight ratio, where L=81%, a=−1.9, and b=6.2.

Analysis of purity after separation: an Erlenmeyer flask with a volume of 1000 CC was poured with 600 CC of a sulfuric acid aqueous solution with a concentration of 75% by weight, and 3 g of a sample of the separated PET fabric was put into the flask. The flask was heated to 50° C.±5° C. for 1 hour and shaken once every 10 minutes. After that, a funnel with a 3 mm filter screen was used for drainage by evacuation. 200 CC of the sulfuric acid aqueous solution with a concentration of 75% by weight was poured into the funnel to clean the fabric and drainage was performed by evacuation. Then, 200 CC of clean water was poured into the funnel to clean the fabric 2 times, and at each time drainage was performed by suction. The PET fabric was dried in an oven at 105° C. for 2 hours and then weighed 2.984 g, and it was confirmed that the purity was 99.5% as a weight ratio. In each of the embodiments and comparative examples below, this analysis is used and will thus not be repeatedly described.

### Embodiment 2

Similar to embodiment 1, only oxalic acid was used to replace maleic acid, and the obtained PET fabric had a purity of 99.8% as a weight ratio, where L=79%, a=1.2, and b=5.4.

### Embodiment 3

Similar to embodiment 1, only calcium hypochlorite was used to replace sodium hypochlorite, and the obtained PET fabric had a purity of 99.4% as a weight ratio, where L=84%, a=−0.4, and b=4.6.

### Embodiment 4

20 g of PET polyester-wool blended fabric (where L=18%, PET polyester was 73% by weight, and wool was 27% by weight) was placed into a 1 L pressure-resistant reaction tank, 500 ml of water, 12 g of acetic acid, 1.5 g of sodium hypochlorite were put therein, and the mixture was stirred for 2 hr at a temperature of 165° C. After that, the wool was degraded into wool keratin.

Then, the temperature was lowered to 60° C., the PET polyester and the aqueous solution of wool keratin were separated through a 2 mm filter screen, and the PET polyester fabric was washed with 100 ml of water.

The PET polyester was dried at 105° C. for 2 hours, and the obtained PET fabric had a purity of 99.2% as a weight ratio, where L=84%, a=2.7, and b=7.2.

### Embodiment 5

Similar to embodiment 4, only oxalic acid was used to replace acetic acid, and the obtained PET fabric had a purity of 99.9% as a weight ratio, where L=85%, a=1.8, and b=5.9.

### Embodiment 6

Similar to embodiment 4, only 2.5 g of sodium hypochlorite was used to replace 1.5 g of sodium hypochlorite, and the obtained PET fabric had a purity of 99.9% as a weight ratio, where L=88%, a=−0.1, and b=4.3.

### Comparative Example 1

20 g of PET polyester-wool blend fabric (where L=19%, PET polyester was 92% by weight, and wool was 8% by weight) was placed into a 1 L pressure-resistant reaction tank, 500 ml of water and 10 g of maleic acid were put therein, and the mixture was stirred at a temperature of 165° C. for 2 hours. After that, the wool was degraded into wool keratin.

Then, the temperature was lowered to 80° C., the PET polyester and the aqueous solution of wool keratin were separated through a 3 mm filter screen, and the PET polyester fabric was washed with 100 ml of water.

The PET polyester fabric was dried at 105° C. for 2 hours, and the obtained PET fabric had a purity of 99.1% as a weight ratio, where L=58%, a=4.8, and b=8.7.

### Comparative Example 2

20 g of PET polyester-wool blended fabric (where L=20%, PET polyester was 76% by weight, and wool was 24% by weight) was placed into a 1 L pressure-resistant reaction tank, 500 ml of water and 10 g of formic acid were put therein, and the mixture was stirred at a temperature of 170° C. for 2 hours. After that, the wool was degraded into wool keratin.

Then, the temperature was lowered to 60° C., the PET polyester and the aqueous solution of wool keratin were separated through a 3 mm filter screen, and the PET polyester fabric was washed with 100 ml of water.

The PET polyester was dried at 105° C. for 2 hours, and the obtained PET fabric had a purity of 99.2% as a weight ratio, where L=63%, a=4.9, and b=9.4.

From the above experimental results, it can be found that, in Embodiment 1 to Embodiment 6, the recycling method of a polyester wool blended fabric of the disclosure was used, and soaking was performed by using an acidic aqueous solution containing an oxidizing agent.

Therefore, polyester fabric with an L value of 75% or more can be obtained. In contrast, no oxidizing agent was used in Comparative Example 1 and Comparative Example 2. Therefore, polyester fabric with an L value of more than 75% cannot be obtained. In the manufacturing process, by the addition of an oxidizing agent having a concentration of 0.4% by weight and being under an acidic condition, dyes and other coloring substances can be effectively removed from the PET fabric, such that the fabric is exhibited as white (where the L value is 75% or more), the a value is maintained at ±4, and the b value is maintained at ±8. As the concentration of the oxidizing agent is increased to 1.2%, the a value and the b value approaches 0. As the concentration of the oxidizing agent is reduced to 0.06%, the absolute value of the a value approaches 4, and the absolute value of the b value approaches 8.

In summary of the foregoing, the disclosure provides a recycling method of a polyester wool blended fabric including both separation and decolorization procedures, where soaking is performed by using an acidic aqueous solution containing an oxidizing agent, so as to degrade the wool and remove the dye on the polyester fabric at the same time, and in the same manufacturing process, polyester and wool can be separated, and the decolorized polyester fiber can be obtained. Therefore, compared with the conventional art where it is required to first obtain polyester fabric by degrading wool, then perform decolorization by extracting dyes from the polyester fabric with a solvent, the costs can be reduced and the procedures can be simplified. Moreover, the obtained polyester fabric has high quality, high safety, and low costs. Accordingly, the quality of recycled polyester fabric can be improved and the application fields can be widened, facilitating the subsequent mechanical or chemical recycling of polyester fibers.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A recycling method of a polyester wool blended fabric, the method comprising:
putting a polyester wool blended fabric containing a dye into an acidic aqueous solution containing an oxidizing agent for heating and soaking, so as to degrade a wool in the polyester wool blended fabric, and perform decolorization at the same time to remove the dye; and
obtaining a polyester fabric by filtration.

2. The recycling method according to claim 1, wherein the dye comprises a physical dye or a chemical dye.

3. The recycling method according to claim 1, wherein the soaking is performed at a temperature higher than a glass transition temperature of polyester.

4. The recycling method according to claim 1, wherein the soaking is performed in the acidic aqueous solution at a temperature of 130° C. to 200° C.

5. The recycling method according to claim 1, wherein the acidic aqueous solution contains an organic acid, and the organic acid is a monoacid, a dibasic acid, or an acid anhydride having 1 to 18 carbons, and comprises formic acid, acetic acid, acetic anhydride, oxalic acid, propionic acid, malonic acid, butyric acid, succinic acid, valeric acid, glutaric acid, caproic acid, adipic acid, isooctanoic acid, citric acid, maleic acid, maleic anhydride, benzoic acid, or cyclohexanoic acid.

6. The recycling method according to claim 5, wherein the organic acid in the acidic aqueous solution has a concentration of 0.1 wt % to 3.0 wt %.

7. The recycling method according to claim 1, wherein the oxidizing agent in the acidic aqueous solution has a concentration of 0.06 wt % to 1.2 wt %.

8. The recycling method according to claim 1, wherein a weight ratio of the polyester wool blended fabric to the acidic aqueous solution is 1:8 to 1:30.

9. The recycling method according to claim 1, wherein the soaking is performed for a duration of 0.5 hours to 3 hours.

10. The recycling method according to claim 1, wherein the oxidizing agent comprises hydrogen peroxide, potassium permanganate, calcium hypochlorite, ozone, nitric acid, nitrate, sodium chlorate, calcium chlorate, chlorates, perchlorate, sodium hypochlorite, hypochlorite, sodium perborate, sodium dichromate, dichromate, or a combination thereof.

11. The recycling method according to claim 1, wherein the filtration is by using a filter screen of 1 mm to 30 mm.

12. The recycling method according to claim 1, wherein the polyester fabric that is obtained has an L value of 75% or more, an a value of ±4, and a b value of ±8.
